(19) United States
(12) Patent Application Publication
(10) Pub. No.: US 2010/0187203 A1
(43) Pub. Date: Jul. 29, 2010

(54) MULTI-WIRE ELECTRON DISCHARGE MACHINE

(75) Inventors: Eberhard Bamberg, Salt Lake City, UT (US); Dinesh R. Rakwal, Salt Lake City, UT (US)

Correspondence Address: Ballard Spahr LLP, SUITE 1000, 999 PEACHTREE STREET, ATLANTA, GA, 30309-3915, US

(73) Assignee: University of Utah Research Foundation, Salt Lake City, UT (US)

(21) Appl. No.: 12/524,144

(22) PCT Filed: Jan. 25, 2008
(86) PCT No.: PCT/US08/52133

§ 371 Date: Apr. 13, 2010

Related U.S. Application Data
(60) Provisional application No. 60/886,650, filed on Jan. 25, 2007.

(51) Int. Cl. B23H 1/04

(52) U.S. Cl. 219/69.12

(57) ABSTRACT

A multi-wire electron discharge machine includes a first wire electrode for creating an electrical discharge between the first electrode wire and a semiconductor ingot, a second wire electrode for creating an electrical discharge between the second electrode wire and the semiconductor ingot, and a wire guide for maintaining the first wire electrode in a spaced apart and generally parallel orientation with respect to the second wire electrode across a semiconductor ingot slicing area.

### GOVERNMENTAL INTERESTS

This invention was made with government support under Grant number NSF-0512897 awarded by the National Science Foundation. The United States government has certain rights to this invention.

### FIELD OF THE INVENTION

The invention relates generally to semiconductor manufacturing and more specifically to a multi-wire electron discharge machine for simultaneously slicing multiple semiconductor wafers from a semiconductor ingot.

### BACKGROUND OF THE INVENTION

The material utilization associated with the use of prior abrasive machining techniques to slice semiconductor wafers from a semiconductor ingot is relatively poor. Prior art germanium wafer fabrication techniques typically involve using a wire saw. The prior art abrasive wire saw typically uses a brass wire with a diameter ranging from approximately 150 microns to approximately 180 microns. The brass wire is typically pulled through silicon carbide slurry. The use of this prior art wafer slicing technique typically results in a width cut ranging from approximately 180 microns to approximately 200 microns. When such a prior art wire saw is used to slice semiconductor wafers having a thickness of approximately 300 microns from a semiconductor ingot, typically only 60-62.5% of the semiconductor ingot is actually turned into semiconductor wafers. The rest of the semiconductor ingot, often as much as 37.5% to 40%, is machined away by the prior art wire saw. The typical overcut ranges from approximately 5 microns to approximately 10 microns, and the typical kerf loss ranges from approximately 160 microns to approximately 200 microns.

Furthermore, during the semiconductor wafer slicing process using a prior art wire saw, heat is typically generated as a result of friction. The heat typically increases the temperature of the prior art wire saw wire. The heat generated typically increases the temperature of the wire saw wire in a non-uniform manner. For example, the wire saw wire may have a uniform temperature at the beginning of the cut. The middle of the cut is typically the longest cutting length and the greatest amount of heat is generated at this point in the cut. As a result, the temperature of the wire saw wire at the exit point of the cut will be relatively hotter than the temperature of the wire saw wire at the entry point of the cut. This causes the wire saw wire to become tapered and can lead to a tapered cut. The non-uniform temperature of the wire saw wire during the cutting process may affect the flatness of the machined surface of the semiconductor wafer.

### SUMMARY OF THE INVENTION

One aspect of the invention is directed to a multi-wire electron discharge machine. The multi-wire electron discharge machine includes a first wire electrode for creating an electrical discharge between the first electrode wire and a semiconductor ingot, a second wire electrode for creating an electrical discharge between the second electrode wire and a semiconductor ingot, and a wire guide for maintaining the first wire electrode in a spaced apart and generally parallel orientation with respect to the second wire electrode across a semiconductor ingot slicing area.

Another aspect of the invention is directed to a multi-wire electron discharge machine. The multi-wire discharge machine includes means for creating an electrical discharge between the first electrode wire and a semiconductor ingot, means for creating an electrical discharge between the second electrode wire and a semiconductor ingot, and means for maintaining the first wire electrode in a spaced apart and generally parallel orientation with respect to the second wire electrode across a semiconductor ingot slicing area.

Another aspect of the invention is directed to a multi-wire electron discharge machine. The multi-wire discharge machine includes a plurality of wire electrodes, a wire guide for maintaining each of the plurality of wire electrodes in a spaced apart and generally parallel orientation with respect to an adjacent one of the plurality of wire electrodes across a semiconductor ingot slicing area.

### BRIEF DESCRIPTION OF THE DRAWINGS

FIG. 1 is a schematic diagram of an example of one embodiment of a multi-wire EDM;

FIG. 2 is an illustration of examples of glass tubes for guiding the wires from the spools to the tension pulleys of the multi-wire EDM of FIG. 1;

FIG. 3 is an illustration of an example of primary and secondary tension pulleys in the multi-wire EDM of FIG. 1;

FIG. 4 is an illustration of an example of the work area defined by the spacings between the left and right wire guides in the multi-wire EDM of FIG. 1;

FIG. 5 is an illustration of an example of a pulleys and a roller in the multi-wire EDM of FIG. 1.

### DETAILED DESCRIPTION OF THE PREFERRED EMBODIMENTS

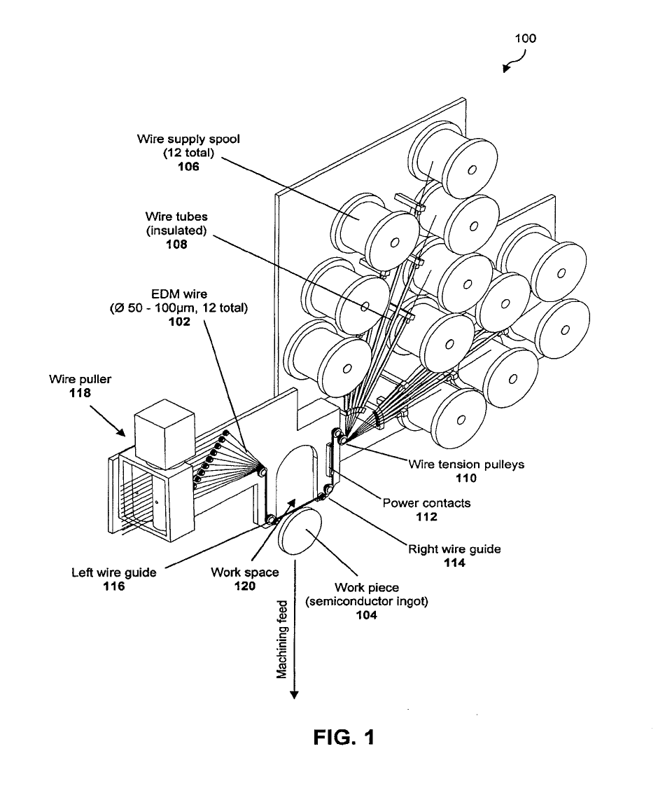

Referring to FIG. 1 a schematic diagram of an example of one embodiment of a multi-wire electron Discharge machine (EDM) 100 is shown. The example multi-wire EDM 100 includes twelve wires 102 for simultaneously slicing twelve semiconductor wafers from a semiconductor ingot 104. Once a raw semiconductor boule has been shaped, the semiconductor wafers are sliced from the shaped semiconductor boule or semiconductor ingot 104 using the multi-wire EDM 100. The typical wire diameter of the wires 102 used in the multi-wire EDM 100 ranges from approximately 50 microns to approximately 200 microns. The typical overcut ranges from approximately 5 microns to approximately 30 microns. The typical kerf loss ranges from approximately 60 microns to approximately 260 microns.

The work piece or semiconductor ingot 104 is typically immersed in a dielectric fluid while being machined using the multi-wire EDM wire 100. In one embodiment, a nozzle is used to force flushing with dielectric fluid. In one embodiment, the workpiece is submerged in the dielectric fluid. It should be noted that while the use of EDM wires 102 having a number of different diameters have been described, the use of EDM wires 102 having alternative diameters are also considered to be within the scope of the invention.

The multi-wire EDM 100 includes twelve EDM wire supply spools 106, twelve wire tubes 108, first and second wire tension pulleys 110, power contacts 112, right and left wire guides 114, 116, and a wire puller 118. The wire tubes 108 are insulated wire tubes. In one embodiment, the wire tubes 108 are glass tubes. The wire tubes 108 guide the EDM wires 102 from the EDM wire supply spools 106 to the first and second wire tension pulleys 110. The first and second wire tension pulleys 110 create a pre-defined amount of tension in the EDM wires 102. The right and left wire guides 1114, 116 position the EDM wires 102 across the machining area 120. The twelve EDM wires 102 simultaneously slice twelve semiconductor wafers from a semiconductor ingot 104 in the machining area 120 as the semiconductor ingot 104 is moved through twelve EDM wires 102 positioned across the machining area 120. The EDM wires 102 are continuously pulled by the wire puller 118. It should be noted that while a multi-wire EDM 100 for simultaneously slicing twelve semiconductor wafers from a semiconductor ingot 104 is shown, multi-wire EDMs having a greater or fewer number of EDM wires for simultaneously slicing a greater or fewer number of semiconductor wafers from a semiconductor ingot are also considered to be within the scope of the invention.

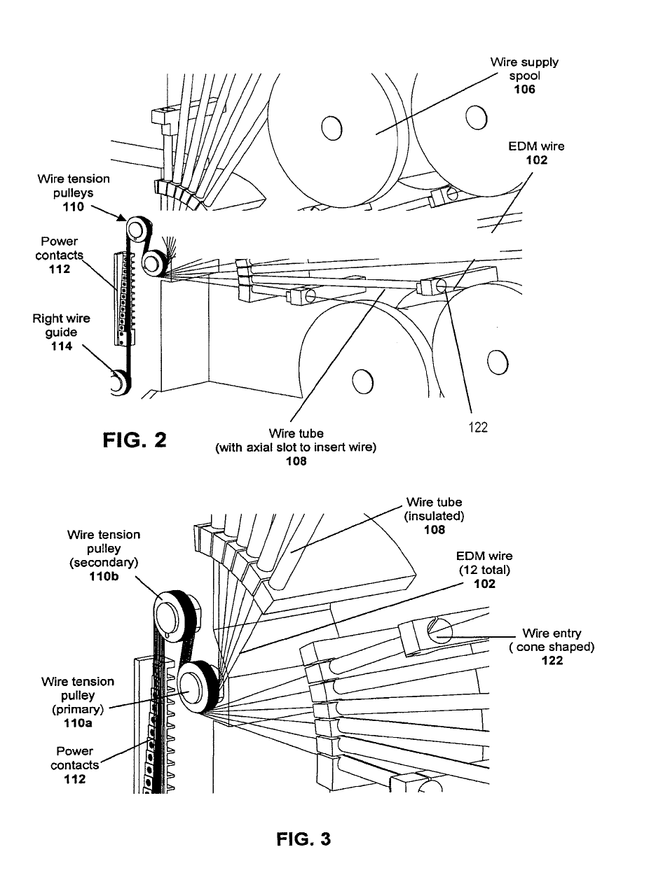

Referring to FIG. 2, an illustration of examples of glass tubes 108 for guiding the wires 102 from the spools 106 to the tension pulleys 110 in the multi-wire EDM 100 of FIG. 1 are shown. The sideways motion of the wire 102 as it comes off the spool 106 is controlled by a conical wire entry 122. Each of the individual twelve EDM wires 102 are guided from their associated EDM wire supply spools 106 to the tension pulleys 110 via an associated glass tube guide 108. In one embodiment, the sideways motion of each of the individual EDM wires 102 as the EDM wire 102 comes off the EDM wire supply spool 106 and into the glass tube guides 108 is controlled by a conical wire entry 122. The conical entry 122 accommodates the EDM wire 102 movement as the EDM wire 102 unwinds from the associated EDM wire supply spool 106. In one embodiment, each of the glass tubes 108 includes an axial slot for receiving an EDM wire 102 from the associated EDM wire supply spool 106. The axial slot allows the EDM wire 102 to be placed within the glass tube 108 without having to feed the EDM wire 102 through the entire length of the glass tube 108.

Referring to FIG. 3, an illustration of an example of primary and secondary tension pulleys 110 in the multi-wire EDM 100 of FIG. 1 is shown. The EDM wires 102 are guided from the EDM wire spools 106 to the tension pulleys 110. In one embodiment, the tension pulleys 110 include a primary and a secondary tension pulley 110a, 110b. The guided EDM wires 102 are wrapped around the first and second tension pulleys 110a, 110b. The primary and secondary tension pulleys 110a, 110b are connected to primary and secondary brakes, respectively. The primary and secondary brakes exert a torque to the first and second pulleys 110a, 110b, respectively. The torque applied to the primary and secondary tension pulleys 110a, 110b creates tension in the EDM wires 102. The torque generated tension maintains the EDM wire 102 in a generally straight orientation and minimizes EDM wire vibration. In one embodiment, the EDM wire tension ranges from approximately 85% to approximately 90% of the failure strength of the EDM wire. Generally speaking, the higher the EDM wire tension, the better the machined semiconductor surface finish and the better the machined semiconductor surface flatness. However, if the EDM wire tension is too high, there is an increased probability of EDM wire breakage. Therefore it is desirable to determine a balance between the quality of desired semiconductor machined surfaces and the probability of EDM wire breakage in determining the appropriate amount of tension to apply to the EDM wires 102.

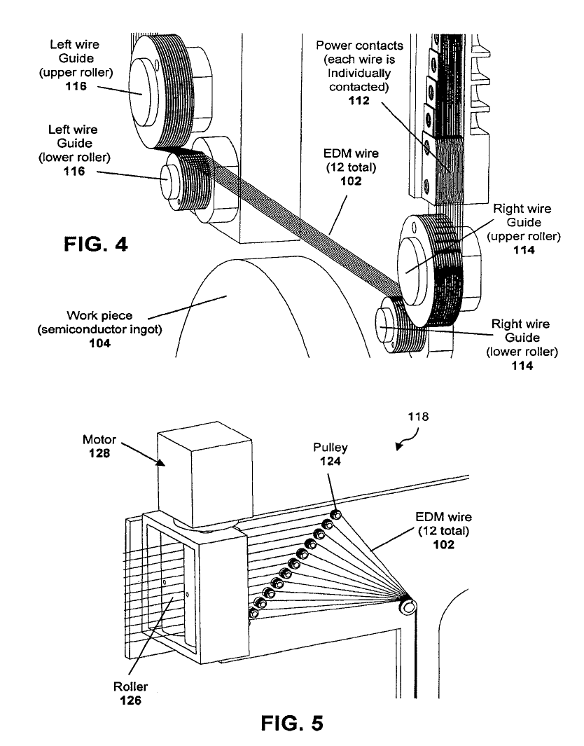

Referring to FIG. 4, an illustration of an example of the work area 120 defined by the spacings between the left and right wire guides 116, 114 in the multi-wire EDM 100 of FIG. 1 is shown. The EDM wires 102 pass from the secondary tension pulley 110b through the power contacts 112 to the right wire guide 114. In one embodiment, the power contacts 112 include twelve individual power contacts. A power contact 112 is provided for each EDM wire 102. The power contacts 112 are insulated from one another. The power contacts 112 are electrically coupled to one or more pulse generators (not shown). In one embodiment, the twelve power contacts 112 are electrically coupled to a single pulse generator. In one embodiment, each of the power contacts 112 is electrically coupled to a separate pulse generator that is dedicated to a single power contact 112. Each power contact 112 transmits an electrical signal received from a pulse generator (not shown) to the associated EDM wire 102.

After passing the power contacts 112, the EDM wires 102 pass from the right wire guide 114 to the left wire guide 116. The area between the right wire guide 114 and the left wire guide 116 defines the semiconductor wafer slicing work area 120. In one embodiment, the left and right wire guides 116, 114 each include v-grooves that precisely guide the EDM wires 102 from the right wire 114 guide to the left wire guide 116 across the semiconductor wafer slicing work area 120. In one embodiment, the v-grooves in the left and right wire guides 116, 114 are spaced approximately 390 microns apart when an EDM wire 102 having a diameter of approximately 50 microns is used, thereby creating an inter-wire space of approximately 340 microns. An assumption is made that the EDM semiconductor wafer slicing process creates an overcut of approximately 20 microns on either side of the EDM wire 102. As a result, the described example multi-wire EDM 100 simultaneously slices twelve semiconductor wafers having a thickness of approximately 300 microns from a shaped semiconductor boule or semiconductor ingot 104. While one mechanism for maintaining an inter-wire space between adjacent EDM 102 wires is described, alternative mechanisms for maintaining an inter-wire space between adjacent EDM 102 wires is also considered to be within the scope of the invention. Also one example of a multi-wire EDM wire spacing is described for generating 300 micron thick semiconductor wafers, alternative EDM wire spacings for generating semiconductor wafers of alternative thicknesses are also considered to be within the scope of the invention.

Referring to FIG. 5 an illustration of an example of a pulleys 124 and a roller 126 in the multi-wire EDM 100 of FIG. 1 is shown. The wire puller 118 generally pulls the EDM wires 102 from the EDM wire spools 106 through the semiconductor wafer slicing work area 120. In this example, there are a total of twelve wire puller pulleys 124, one for each EDM wire. The wire pulleys guide 124 the EDM wires 102 from the left wire guide 1116 into the wire puller 118. In one embodiment, the wire puller 118 includes two rotatable drums 126 and a motor 128 for rotating the two rotatable drums 126. The motor 128 rotates the two rotatable drums 126, which in turn pull the EDM wires 102 from the EDM wire spools 106. In operation, the EDM wires 102 are continuously pulled by the two rotating drums 126 inside the wire puller 118.

Since each of the EDM wires 102 are electrically charged, the EDM wires 102 are guided to provide electrical contact with the power contacts 112 while preventing contact with the other conductive parts of the multi-wire EDM 100. Contact between the EDM wires 102 and a conductive part of the EDM 100 would create a short circuit thereby disrupting the semiconductor wafer slicing process. As a result, all the EDM wire 102 can only come into contact with non-conductive materials when it is not in contact with the power contact 112. For example, the sections of the EDM wire spools 106, wire tubes 108, the tension pulleys 110, the wire guides 114, 116, the wire puller pulleys 124, and the two rotatable drums 126 that come into contact with the EDM wires 102 are manufactured from non-conductive materials. In one embodiment, the EDM wire supply spools 106 are manufactured from plastic. In one embodiment, the wire tubes 108 are made from glass. In one embodiment the wire tension pulleys 110, the wire tubes 108, the right and left wire guides 114, 116, the wire puller pulleys 124, and the rotatable drums 126 are made from ceramic. In one embodiment, each EDM wire 102 is powered by its own pulse generator (not shown). To avoid uncontrolled discharges by neighboring EDM wires 102, it is desirable to keep the EDM wires 102 electrically insulated from each other during semiconductor wafer slicing operations.

During the semiconductor wafer slicing process, the multi-wire EDM 100 cuts through and removes semiconductor material through highly localized melting of the semiconductor material and a subsequent evaporation of the material. As such mechanical stresses that are generated on the semiconductor wafers during the semiconductor material cutting and removal are relatively low.

In one embodiment, the multi-wire EDM 100 utilizes extremely small EDM wires 102 having diameters as low as approximately 25 microns. In one embodiment, the multi-wire EDM 100 uses EDM wires 102 having diameters ranging from approximately 50 microns to approximately 75 microns. Such EDM wires 102 are typically used in an industrial setting where it is desirable to minimize EDM wire breakage. Using an EDM wire 102 having a diameter of approximately 50 microns typically results in a width of cut ranging from approximately 60 microns to approximately 80 microns. When a multi-wire EDM 100 using a 50 micron EDM wire is used to slice semiconductor wafers having a thickness of approximately 300 microns, typically 79-83% of the semiconductor material in the semiconductor ingot 104 is utilized for semiconductor wafers, while 17-21% of the semiconductor material in the semiconductor ingot 104 is lost as waste due to the EDM machining process.

One embodiment of a multi-wire EDM 100 includes a first wire electrode 102 for creating an electrical discharge between the first electrode wire 102 and a semiconductor ingot 104, a second wire electrode 102 for creating an electrical discharge between the second electrode wire 102 and a semiconductor ingot 104, and a wire guide 114, 116 for maintaining the first wire electrode 102 in a spaced apart and generally parallel orientation with respect to the second wire electrode 102 across a semiconductor ingot slicing area 120.

One embodiment of a multi-wire 100 discharge machine includes means for creating an electrical discharge between the first electrode wire 102 and a semiconductor ingot 104, means for creating an electrical discharge between the second electrode wire 102 and a semiconductor ingot 104, and means for maintaining the first wire electrode 102 in a spaced apart and generally parallel orientation with respect to the second wire electrode 102 across a semiconductor ingot slicing area 120.

One embodiment of a multi-wire discharge machine 100 includes a plurality of wire electrodes 102, a wire guide 114, 116 for maintaining each of the plurality of wire electrodes 102 in a spaced apart and generally parallel orientation with respect to an adjacent one of the plurality of wire electrodes 102 across a semiconductor ingot slicing area 120.

Each EDM wire 102 in the multi-wire EDM 100 discharges electrical energy in the form of sparks that very locally melt and vaporize the material of the semiconductor ingot 104. The rate at which the multi-wire EDM 100 can slice through the semiconductor ingot 104 is typically limited to the rate at which the semiconductor material is melted and vaporized. In general, greater electrical discharges in the form of sparks melt and vaporize relatively greater amounts of semiconductor material, thereby allowing the multi-wire EDM 100 to slice the semiconductor boule 104 at a relatively faster rate. However, the greater discharge energies tend to increase the amount of subsurface damage in the form of microcracks. In one embodiment, the discharge energy is limited to a level that minimizes subsurface damage. In one embodiment, the discharge energy is limited to a level that eliminates subsurface damage. In one embodiment, relatively smaller EDM wires 102 are used in the multi-wire EDM 100 and the discharged frequency maximized to increase the machining speed of the multi-wire EDM 100 without increasing the subsurface damage.

In one embodiment, the orientation of the semiconductor ingot 104 is generally horizontal such that the longitudinal axis of the semiconductor ingot 104 is generally perpendicular to the gravity field. This will minimize or eliminate unwanted movement of the wafers as the EDM wires 102 of the multi-wire EDM 100 slice through the semiconductor ingot 104.

The movement of the EDM wires 102 of the multi-wire EDM 100 relative to the semiconductor ingot 104 is achieved through a mechanism that creates relative motion between the EDM wires 102 and the semiconductor workpiece or ingot 104. In one embodiment, this is achieved by using a vertical linear axis that controls the movement of the EDM wires 102 of the multi-wire EDM 100 in the vertical direction and allows the EDM wires 102 to penetrate the semiconductor ingot 104 from the top towards the bottom of the semiconductor ingot 104. In one embodiment, this is achieved by using a vertical linear axis that controls the movement of the EDM wires 102 of the multi-wire EDM 100 in the vertical direction and allows the EDM wires 102 to penetrate the semiconductor ingot 104 from the bottom towards the top of the semiconductor ingot 104.

In one embodiment, the semiconductor ingot 104 is actuated in the vertical direction by a vertical linear axis that causes the semiconductor ingot 104 to penetrate the workspace of the EDM wires 102 of the multi-wire EDM 100 from the top of the semiconductor ingot 104 towards the bottom of the semiconductor ingot 104. In one embodiment, the semiconductor ingot 104 is actuated in the vertical direction by a vertical linear axis that causes the semiconductor ingot 104 to penetrate the workspace of the EDM wires 102 of the multi-wire EDM 100 from the bottom of the semiconductor ingot 104 towards the top of the semiconductor ingot 104.

While the described embodiments of the multi-wire EDM 100 actuate either the EDM wires 102 or the semiconductor ingot 104 in the vertical direction to create the relative motion between the EDM wires 102 and the semiconductor ingot 104 needed for the slicing, this relative motion can also be created in an alternative direction, such as for example, the horizontal direction or any other arbitrary direction as long as the resulting relative motion between the EDM wires 102 and the semiconductor ingot 104 causes the EDM wires 102 to penetrate the semiconductor ingot 104 without departing from the spirit of the invention. Alternative mechanisms for generating the relative motion between the EDM wires 102 and the semiconductor ingot 104 includes rotating the semiconductor ingot 104 towards the EDM wires 102.

One embodiment of the multi-wire EDM 100 allows the simultaneous slicing of an entire length of a semiconductor ingot 104 into wafers. The use of a multi-wire EDM 100 typically results in reduced subsurface damage. The use of a multi-wire EDM 100 machine may increase material utilization thereby increasing the overall yield of wafer production from a semiconductor ingot 104 by as much as 30% when compared to the use of prior art wafer slicing technologies.

1. A multi-wire electron discharge machine comprising:
a first wire electrode for creating an electrical discharge between the first electrode wire and a semiconductor ingot;
a second wire electrode for creating an electrical discharge between the second electrode wire and the semiconductor ingot; and
a wire guide for maintaining the first wire electrode in a spaced apart and generally parallel orientation with respect to the second wire electrode across a semiconductor ingot slicing area.

2. The multi-wire electron discharge machine of claim 1, wherein the wire guide comprises first and second insulated wire tubes operable to guide the first and second wire electrodes across the semiconductor ingot slicing area.

3. The multi-wire electron discharge machine of claim 2, wherein the first and second insulated wire tubes comprise glass tubes.

4. The multi-wire electron discharge machine of claim 2, further comprising a conical wire entry for guiding first and second wire electrodes from first and second wire supply spools to first and second insulated wire tubes, respectively.

5. The multi-wire electron discharge machine of claim 2, wherein each of the first and second insulated wire tubes includes an axial slot operable to receive the associated one of the first and second wire electrodes.

6. The multi-wire electron discharge machine of claim 2, further comprising first and second wire guides operable to guide the first and second wire electrodes across the semiconductor ingot slicing area.

7. The multi-wire electron discharge machine of claim 1, further comprising a wire puller for pulling the first and second wire electrodes across the semiconductor ingot slicing area.

8. A multi-wire electron discharge machine comprising:
means for creating an electrical discharge between the first electrode wire and a semiconductor ingot;
means for creating an electrical discharge between the second electrode wire and the semiconductor ingot; and
means for maintaining the first wire electrode in a spaced apart and generally parallel orientation with respect to the second wire electrode across a semiconductor ingot slicing area.

9. A multi-wire electron discharge machine comprising:
a plurality of wire electrodes; and
a wire guide for maintaining each of the plurality of wire electrodes in a spaced apart and generally parallel orientation with respect to an adjacent one of the plurality of wire electrodes across a semiconductor ingot slicing area.
